(19) United States
(12) Patent Application Publication
(10) Pub. No.: US 2007/0029828 A1
(43) Pub. Date: Feb. 8, 2007

(54) Catch-it

(76) Inventor: Julia Pilas, Morristown, NJ (US)

Correspondence Address: Julia Pilas, 4 Lidgerwood Pkwy, Morristown, NJ, 07960, US

(21) Appl. No.: 11/240,300

(22) Filed: Sep. 28, 2005

Related U.S. Application Data
(60) Provisional application No. 60/705,148, filed on Aug. 4, 2005.

(51) Int. Cl. A01K 29/00

(52) U.S. Cl. 294/1.5

(57) ABSTRACT

“Catch-it” is a new invention that will allow the pet walking process to be a more pleasurable one. With the “Catch-it” you don't have to See-it, Smell-it, or Touch-it, you will not leave any dog waste behind and there is no need to bend. Simply place the “Catch-it” under the pet when he gets into the pooping position allowing the poop to go directly into the bag. When he is done release the lever to close the bag. Once the bag is closed on the rims lift the “Catch-it toward you, take the pull string; pull it in a downward direction; the bag with the poop in it will remain closed, tighten up and come off the rims at the same time. Thus you won't have to “See it, Smell it, or Touch it. The “Catch-it will also prevent any waste from being left behind and there is no need to bend to pick anything up.

### CROSS-REFERENCE TO RELATED APPLICATIONS

This claim has priority to Provisional Application 60/705,148 filed Aug. 4, 2005.

### STATEMENT REGARDING FEDERALLY SPONSORED RESEARCH OR DEVELOPEMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention is dedicated to the art of picking up dog poop without having to “See it, Smell it, or Touch it”. With this invention there is no need to bend and no possibility of getting dog poop on your hands, and most importantly no possibility of leaving any excess dog waste behind on anyones property.

### BRIEF SUMMARY OF THE INVENTION

“Catch-it” is a new invention that will allow the pet walking process to be a more pleasurable one. Simply place the “Catch-it” under the pet when he gets into the pooping position, and when he is done release the lever to close the bag. This will prevent the poop from hitting the ground and being left behind. Once the bag is closed take the pull string and pull it in a downward direction. The bag with the poop in it will remain closed, tighten up, and come off the rims at the same time. Thus you won't have to “See it, Smell it, or Touch it.

### BRIEF DESCRIPTION OF THE SEVERAL VIEWS OF THE DRAWING

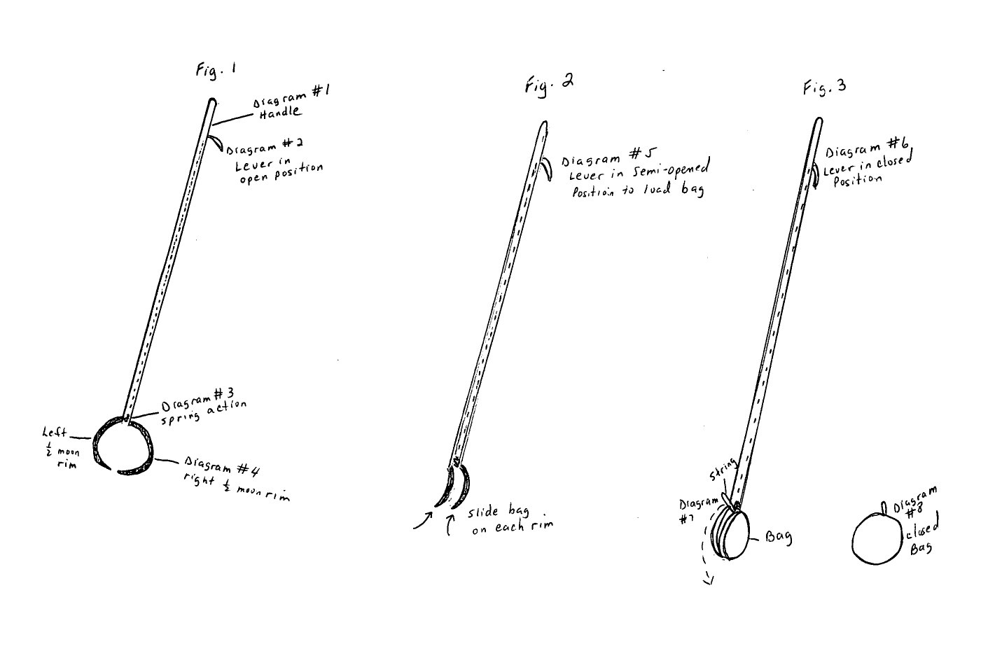

The Catch-it is made up of 8 Figures. FIG. 1—Handle is plastic material approximately 3 feet to 4 feet long and ½ inch in diameter. FIG. 2—Lever is used to open bag, semi-open bag, and close bag. FIG. 3—Spring mechanism attaches two ½ moon rims approximately 7 inches in diameter total. FIG. 4—Rims consist of a right rim for bag and bag loading and left rim for bag and bag loading. FIG. 5—Diagram of lever in semi-opened position to load bag. FIG. 6—Diagram of lever in closed position to remove bag. FIG. 7—Bag closed and ready to be dismounted. FIG. 8—Closed and dismounted bag.

### DETAILED DESCRIPTION

The Catch-it” is an invention that will enable pet owners to walk their dogs and pick-up after them without having to “See it, Smell it, or Touch it”. It will also give the pet owner piece of mind knowing that they do no have to worry about leaving any dog waste behind. It is an invention to help make the pet walking task a more enjoyable one.

As seen in “FIG.” 1 diagram #1 “Catch-it” has a handle of approximately 3 feet to 4 feet long, approximately ½ inch in diameter, and made up of plastic material with a lever and an attachment which connects the spring to the lever. Diagram #2 is the lever which has 3 positions. Lever in upward position indicates bag is open, lever semi down position indicates bag is ready to load onto Catch-it, lever all the way down indicates bag is closed with poop in it. Attached to the lever; inside the handle; is a thin wire which is also attached to the spring which controls the two half moon rims at the bottom of the handle. At the same time the lever is activated the thin wire inside the handle activates the rims to move into the open, semi opened, and closed position. Ie: lever in upward position via the thin wire allows rims to open, lever in semi down position allows rims to open to semi position allowing bag to be mounted, lever in closed downward position allows bag to close concealing the dog poop. When the rims are in the semi open position via the lever and wire the bag to hold the poop can be mounted onto the rims. The bag will have two openings at the top with a slight space between the left side and the right side giving access for the rims to enter. The opening will go totally around the top of the bag allowing the left and right rims to totally fit into the bag thus allowing the lever and rim control of the bag. Diagram #3 is the spring mechanism which attaches the two ½ moon rims approximately 7 inches in diameter total and allows the rims to open and close the attached bag with the help of an apparatus inside the handle that connects to the lever. Diagram #4 are the two half moon rims where the bag with the pull string attaches to. Right side of bag attaches to the right rim, left side of bag attaches to the left rim. “FIG.” 2 diagram #5 is “Catch-it” in semi-opened position to allow the bag to be mounted. Put lever in semi-opened position and slide the bag onto the right side of rim and then onto the left side of rim. Pull lever up into the open position and you are ready to walk your dog.

“FIG.” 3 diagram #6 shows the Catch-it with lever in closed position. When the dog appears to be in pooping position direct the open bag under him so that he can poop directly in the bag and once the dog has pooped (see diagram#6) lower the lever to the close position to close the bag. The rims with the bag on it will close in an upward direction and meet together. Diagram #7 shows the bag closed and now you can remove the bag by taking the drawstring and pulling it off the rims in a downward direction. This enables you to avoid seeing, smelling, or touching the poop and ensures no poop will be left behind. Once it is off the rims the bag is closed as shown in Diagram #8 and you are ready to discard the bag with the poop in it.

“Catch-it” is a new invention that is light in weight so it is no bother to carry, it is long enough so that you don't have to bend down, and by releasing the lever in the down position for the closing process it allows both hands to be free for an easier dismounting process. Just simply place it under your pet in the open position when your pet gets into the position to poop. After he has pooped into the bag you don't have to “See it, Smell it, or Touch it”, just simply release the lever, the rims will go in an upward closing position, the bag will close, you then pull the string in a downward direction, the bag will slide off and tighten into a totally closed position at the same time. Unlike other inventions you will not have to worry about leaving any dog waste behind or have to be concerned with the impossible task of picking up the dog waste on a grassy area.

1. The “Catch-it” is a new and improved invention to pick up dog poop without having to see it, smell it, or touch it. When the pet goes into the pooping position simply place the “Catch-it” under the pet so he can poop directly into the bag. The “Catch-it” will leave no dog waste behind on any ones property.
The “Catch-it” is a new invention that is designed to make the pet walking process a more pleasurable one. It is comprised of a plastic handle approximately 3 feet-4 feet long and ½ inch in diameter. On said handle is a lever which is used to open, semi open and close the poop bag located at the bottom of said handle which is mounted onto two ½ moon rims approximately 7 inches total in diameter which are attached to the bottom of said handle. These said rims work together with said lever to open said bag for the pet to poop in, to semi open said bag, to mount said bag onto said rims and to close said bag after pet has pooped. Thus you don't have to see it, smell it, or touch it. Once said bag has been closed just simple pull said bag off said rims and discard.
The “Catch-it” is an invention that will enable pet owners to walk their dogs and pick-up after them without having to see it, smell it, or touch it. The “Catch-it” has a handle of approximately 3 feet to 4 feet long, approximately 1 inch in diameter, and made up of plastic material with a lever and a thin wire inside which connects said lever to a spring that controls two rims. The said lever has 3 positions. Said lever in upward position indicates bag is open, lever semi down position indicates bag is ready to load onto “Catch-it”, said lever all the way down indicates bag is closed with poop in it. Attached to said lever; inside said handle; is a thin wire which is also attached to a spring and two half moon rims located at the bottom of said handle. At the same time said lever is activated the thin wire inside said handle activates said rims to move into the open, semi opened, and closed position. When said rims are in the semi open position via said lever and wire the bag to hold the poop can be mounted onto said rims. The bag will have two openings at the top with a slight space between the left side and the right side giving access for the rims to enter. The opening will go totally around the top of the bag allowing the left and right said rims to totally fit into said bag thus allowing said lever and said rim control of the bag to catch the poop and close it up and pull it off and throw it away. When the dog appears to be in pooping position place the “Catch-it” with said lever in upward position under the pet so that he can poop directly in the bag and once the dog has pooped lower said lever to the close position to close the bag. The said rims with the bag on it will close in an upward direction and meet together. Remove the bag by taking the bag drawstring and pulling it off the said rims in a downward direction. This will enable you to avoid seeing, smelling, or touching the poop and ensures no poop will be left behind. Once it is off said rims the bag will be closed and you are ready to discard said bag with the poop in it. The “Catch-it” is a new invention that is light in weight so it is no bother to carry, it is long enough so that you don't have to bend down, and by releasing said lever in the down position for the closing process it allows both hands to be free for an easier dismounting process. Just simply place it under your pet in the open position when your pet gets into the position to poop. After he has pooped into the bag you don't have to see it, smell it, or touch it, just simple release said lever, said rims will go in an upward closing position, the bag will close, you then pull the string on said bag in a downward direction, the bag will slide off said rims and tighten into a totally closed position at the same time.
